(19) United States
(12) Patent Application Publication
(10) Pub. No.: US 2008/0177618 A1
(43) Pub. Date: Jul. 24, 2008

(54) SYSTEMS AND METHODS FOR ADVERTISEMENT

(76) Inventors: John Liam Funge, Washington, DC (US); Leo Jenkins Scott, Arlington, VA (US)

Correspondence Address: FROST BROWN TODD, LLC, 2200 PNC CENTER, 201 E. FIFTH STREET, CINCINNATI, OH, 45202, US

(21) Appl. No.: 12/016,676

(22) Filed: Jan. 18, 2008

Related U.S. Application Data
(60) Provisional application No. 60/881,155, filed on Jan. 19, 2007.

(51) Int. Cl. G06Q 30/00; G06F 17/00

(52) U.S. Cl. 705/10; 705/14

(57) ABSTRACT

Systems and methods are presented for selection of advertisement by a user that is targeted to the market of the user. Such advertisement selection may be automated without the need for direct communication by the advertiser to the user and can be changed or updated at will.

This application claims priority from provisional patent application Ser. No. 60/881,155, entitled “Systems and Methods for Advertisement,” that was filed on Jan. 19, 2007.

### BACKGROUND OF THE INVENTION

1. Field of the Invention

The present invention relates to advertisement. More particularly, the present invention relates to systems and methods for advertisement.

2. Background of the Invention

The history of mass media may be traced to the 15^{th} century with the invention of the printing press. At first, the spread of media was restricted to a small number of publishers and a limited number of viewers. Over time, new media outlets like radio, film, and television arose, offered widespread access to an ever-increasing variety of voices. Today, the internet and improved media production technologies are ushering in a new era in which the tools for publishing are broadly available, and the potential audience stretches all around the world. Furthermore, such advertisement can be delivered instantly, to anyone, anywhere.

This technological progress has produced a democratizing force. The advent of publishing platforms like blogs, podcasts, and photo and video sharing sites signals an unprecedented rise in user-generated content. This democratizing force will next be manifest in advertising. As users increasingly customize and participate with the media experience, the need arises for a better system that marries advertisements (“ads”) to user-generation in order to boost ad relevancy and, in turn, efficacy.

### BRIEF SUMMARY OF THE INVENTION

As used herein and through this disclosure, “user-generated content” or “user's content” or “content created by the user” in the context of this document is broadly interpreted to mean: content that is explicitly created by the end user; instances where user filters or “programs” existing content (e.g., favorites, play lists, etc.); cases where the user may combine multiple pieces of content to form a derivative work. Other meanings are still possible and within the scope of the present invention.

The present invention discloses systems and methods for advertisement wherein users actively determine which advertisements and optionally the nature of the advertisements that accompany their content—or content they have filtered/programmed/derived. This ad system or method can be used with any media service fueled by user-generated content that is designed to be viewed by an audience.

Many user-generated content services (most often implemented as internet sites) offer ad-sponsored services that enable users to share their content with family, friends, or the public at large. The predominant and conventional business model is to allow users to post their content at no charge (or a minimal charge), and then to associate ads with the content. As a result, viewers of the content effectively pay the cost of the content presentation and distribution—by viewing the ads associated with the respective content. A problem with current approaches is that the user that publishes or controls the content doesn't have control over the type, style, nature and content of the ads that are associated with his or her respective content.

Since the user that published the content doesn't want his or her respective audience to be burdened by ads that are not relevant, that user has an inherent interest in making sure that the ads that appear associated with his or her content are highly relevant to his or her own audience. At the same time, advertisers have an interest communicating their message only to those for whom it is relevant—as well as an interest in gaining further insight into their brand and ad campaigns by analyzing user selections. For example, a photo and video sharing service through which users share their photos and videos with family and friends on personalized sites or spaces within the framework of the photo/video sharing service may offer its users the option to control and select which advertisements will appear when the user's friends and family are viewing the photos and videos that particular user shares. The extent to which the user can potentially control and select the advertisement could optionally include the ability to select: a category (e.g., “automobile ads”), a specific brand (e.g., “Ford”), a specific advertisement format (e.g., choose which specific ad among a group of ads will show, colors, shapes, or chose components from which the system will dynamically create the ad), timing (e.g., “daytime only”), and select sub-targeting with his own content (e.g., “Ford ads on this particular album” and “Coke ads on this album”).

Defined more broadly, the term “portfolio” is used herein and through this disclosure as meaning the overall set of advertisements, regardless of specific classification. Within the portfolio, the advertisements may be classified under specific “classes,” which is defined herein and through this disclosure as the divisions in which the advertisements are placed, including, for example, but not limited to: categories, brands, format, time slots, content, and the like. Within each class, there may be further classification, defined herein and throughout this disclosure as “subclasses,” which could include, for example, but not be limited to: automobiles, wildlife, sports (as subclasses of the class of “category”); or Ford, Chevy and Toyota (as subclasses within the class of “brand”). Thus, a user would be able to choose from specific classes (and subclasses, if applicable) within the portfolio of advertisement presented by the photo and video sharing service.

A practical result of the use of the present invention is that the user that is publishing his album of Thanksgiving photos and videos can decide which ads will be associated with that album and more broadly with his content and account in general. So the user knows generally what sort of ads will appear when his mother comes into the account to see the Thanksgiving album. The user prefers this added level of control and has an incentive to select ads that won't annoy his family and friends, the viewers enjoy the fact that the ads have been thoughtfully selected by someone who knows them, and the advertiser benefits from the better advertisement relevance that naturally results from the alignment of interests between the user sharing his photos and videos and the users respective audience. As can be seen in this example, indeed, the advertisers' and users' interests are aligned. The invention provides the process and technology to enable the process of user-guided advertising.

The present invention overcomes shortcomings in the related art by, among other things, reshaping the roles of consumers and advertisers in order to initiate a dialogue between both parties. Referring to FIG. 1, a visual depiction of the new roles among the parties, according to an exemplary embodiment of the present invention, is presented. In the past, certainly “publishers” have been motivated to target their advertising as appropriate. The present invention presents a novel and unique context—the context where users generate content within the bounds of a larger publishing platform. As a result, the role of the “publisher” in this context changes to the operator of a platform upon which many users can publish (e.g., a photo and video sharing service). Likewise the “publisher” also has the role of securing advertising relationships with advertisers. However, in this case the role of literally deciding the specific ad placement within the published content is only broadly guided by the operator of the publishing platform or the advertiser (e.g., the “publisher” will be the one to decide which ad options the end user can select from). The final determination of specific ads and ad placement within user content is guided by the end user himself. The invention includes, in certain exemplary embodiments, a system in which users are provided an assortment of ads, brands, or categories of ads classified within certain classes from which they choose the most desirable option. The user's selection then dictates the nature of the ads that populate the user's content.

The invention provides, in certain exemplary embodiments, control over which ad options are offered to different users based on a range of criteria, including, but not limited to: demographics, usage patterns, location, and other criteria. The invention generates reports and analytics on what ads users have selected, thereby enabling advertisers to launch campaigns by targeting specific groups of users. Advertising statistics may be optionally presented to the user who selected the ads to be posted on his or her pages or media as well. The system may be optionally configured with the ability for users to share in the advertising revenue that is generated from ads that appear on their respective pages.

### BRIEF DESCRIPTION OF THE DRAWING

FIG. 1 provides an overview of the traditional advertisers, publisher, audience member roles in a conventional advertising scenario.

FIG. 2 shows a relationship between advertisers, users and audience, according to an exemplary embodiment of the present invention.

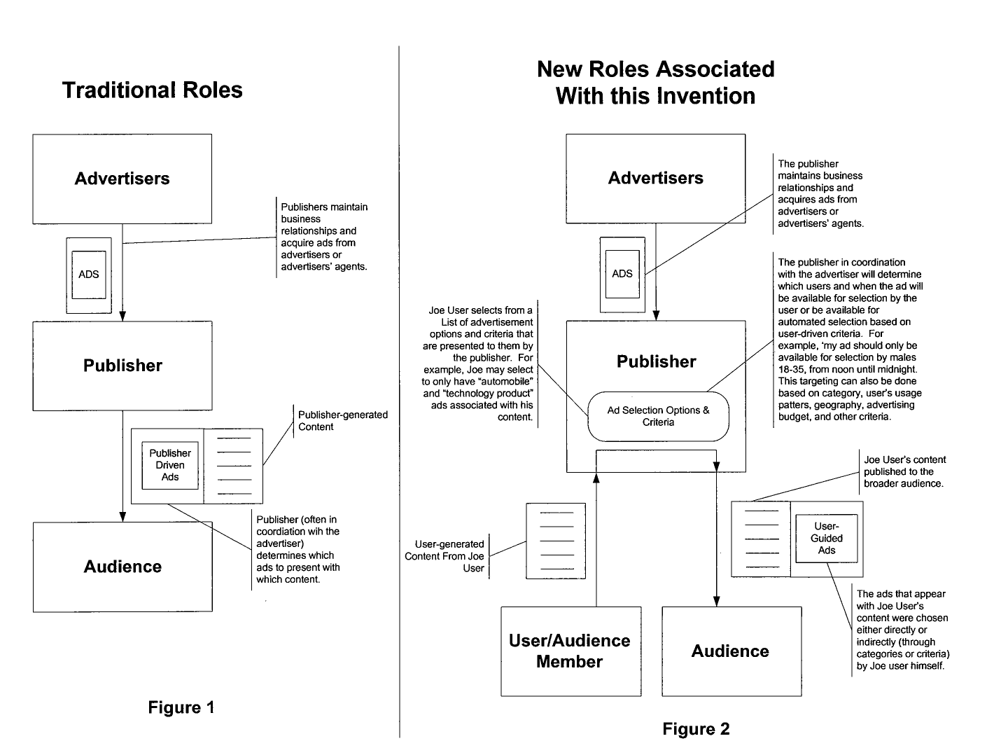

### DETAILED DESCRIPTION OF THE INVENTION

The present invention offers a novel technique for advertisers, users and audience to interact in such a manner to increase a click rate for the advertiser, increase revenue for the user, and to increase exposure to relevant products or services for the audience. In essence, it is a win-win-win configuration to increase efficiency of advertisement and decrease irrelevant product or service placement.

An exemplary embodiment of the present invention is presented in FIG. 2. This figure presents a visual representation of the exemplary modules of an exemplary advertising system according to the present invention. This exemplary embodiment is not limiting of the present invention and is shown herein to present just one aspect of the present invention. Other exemplary embodiments are also possible and apparent to one having ordinary skill in the art after consideration of the present disclosure. Such additional exemplary embodiments are also within the scope of the present invention.

One of the many advantages of the present invention is its applicability to all forms of ad-supported media (television, radio, print, Internet, etc.) where users contribute content or assist in filtering or selection of content. The examples presented herein and in the figure only relate to an internet service for sake of simplicity but it is to be understood that such invention can be applied to all other vehicles of delivering advertisement as well. One having ordinary skill in the art would be cognizant of the applicability of the present invention in all such other delivery vehicles after consideration of the present disclosure. All such delivery vehicles are within the scope of the present invention.

In one exemplary embodiment, the present invention allows advertisement selection by the user. The system provides an array of advertising options (specific ads and/or brands as well as categories of ads) pre-arranged in certain classes (and subclasses, if applicable) that users can choose from. Classes can be segregated by ad options which may include different formats, types of ads, positioning, timing, ability to sub-target ads within the user's content, and other parameters. Users can select the ads or classes/subclasses of ads and ad options that will be associated with their respective content. One example would be a social networking website whereby a user is provided a pallet of advertisement categories (e.g., “Automobiles”, “Clothing”, “Technology Products” etc.). The user would be required to select a prescribed number of ad categories that would be associated with the user's account and profile. Subsequently, any viewer that would view the user's profile or user content associated with his profile would be presented ads from the selected categories. In this example, the social networking site user is guiding the ads based only on category. The specific ads presented within each class would be automatically selected by the system from a catalogue of ads in each category. However, the end-user would guide the ad delivery by selecting the ad classes.

Another variant of the invention can be seen in an example where the user is presented different brands to selection from rather than categories of ads. So, on the social networking site mentioned above, a user may be presented a list of brands (e.g., “Sony”, “Casio”, “Pepsi”, “Dell”, and “BMW”). The users would be required to select a prescribed number of brands from the list. These selections made by the user would determine which brands would be advertised along with the user's content. Another example would be the case where a user is provided a variety of different ads formatted in different ways all for the same brand or multiple brands (e.g., three different ads each picturing a different athlete wearing Nike athletic gear). Based on the user's selection, the site would present ads that corresponded to the user's selection. Another example exists where the user is presented the option to select from a set of different ad components to create a composite ad (e.g., the user may be presented ten different video clips and required to select a prescribed number of clips to create a composite video ad). The resultant composite ad that is created based on the user's selections would be served along with that user's respective content. Another example exists where the user is presented the option to select different guidance criteria (e.g., categories, specific brands, different ad formats, etc.) for different parts of the users content base. So, the user in this social networking site example may select to show automobile ads on his profile page and movie ads on his blog entries. Countless other similar examples are evident to one having ordinary skill in the art after consideration of the present disclosure.

The different criteria selection methods detailed in the prior paragraph above can exist with the same system. So, for example, the operator of the social networking site may choose to offer brand-based selection to women between the ages of 35-55 while offering category-based ad selection to everyone else. The one system can provide numerous types of ad selection methods (by class including brand, by category, etc.) and can vary the ad selection method based on user attributes, including demographic criteria, timing of the day, geography, and end-user usage patterns (e.g., heaviest users select by ads by brand, while light users select by category), and the like.

In a second aspect, the present invention presents ad serving. Ad serving refers to the process of determining which ad to present with the respective content by performing a matching process (either dynamically or pre-processed) whereby targeting criteria are matched to the specific ads in turn determining which ads to display with content. In this case, the targeting criteria is determined by the user's selections and ads are then associated with that user's respective content accordingly. So, the viewers of that user's content or content that the user has programmed or filtered will be exposed to ads governed by the selections made by the user. All ads that viewers see may not necessarily be user-selected. In some cases, a blend of users-selected ads and those not selected by the user may run. This blend may change over time.

The ads may be served in a variety of different ways. The ads may be embedded directly into the content. The ads may appear around the content. There may be interstitial ads. The particular placement of the ad within the content may be apparent to one having ordinary skill in the art and depends on the content and nature of the ad and the web site or material. The association between the user's ad choices and the user's respective audience is an advantageous element of the present invention. This process can apply to most any ad campaign format existing today or new ones in the future.

As shown in FIG. 2, there is an advertiser control module that enables advertisers to design and configure their ad campaigns on the system. The control module enables the control (both manual and automatic-based on system usage patterns) of which ad options are offered to different users based on different criteria such as: demographics, usage patterns, geography, budget, timing and other dimensions. Advertisers can create audience-specific ads and maintain such ads in the advertising library or database. Then, users are offered a list of ads that such user can choose from depending on the interest of the user's audience.

Note that FIG. 2 illustrates an example implementation whereby the advertising system is operated by a publisher. The invention is equally applicable in the context of an advertising network business model where the advertising system is operated by a third party who brokers ads between a network of advertisers and a network of publishers.

Following up on the specificity of advertising to specific audiences, the present system provides reports and analytics on what ads have been selected by which users. Specifically, reports can break down selection by demographics, patterns over time, comparative rankings among different advertisers, correlations between usage patterns and user ad criteria selection as well as viewership and advertisement conversion statistics. The reports may be at a detailed or aggregate level. Advertising statistics may be optionally presented to the user who selected the ads to be posted with his or her pages or media as well. For example, a member of a social networking website using the invention outlined here can be provided viewership and advertisement conversion statistics for the ads that he selected to be presented with his content.

Considering the specificity of content and targeting of the market audience by the user, there will likely be a higher click rate and review rate of ads on user web sites. This increased click rate will result in increased exposure, sales or goodwill of the advertiser, thereby resulting in increased revenue and value. Thus, such increase value to the advertiser can be shared with the user through various modes, including, for example, revenue sharing. The system may be optionally configured with the ability for users to share in the advertising revenue that is generated from ads that appear on their respective pages. Such revenue sharing would be dependent on the number of clicks on ads of specific advertisers or the click rate or some other variable.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

The present invention offers a novel technique for advertisers, users and audience to interact in such a manner to increase a click rate for the advertiser, increase revenue for the user, and to increase exposure to relevant products or services for the audience. In essence, it is a win-win-win configuration to increase efficiency of advertisement and decrease irrelevant product or service placement.

An exemplary embodiment of the present invention is presented in FIG. 2. This figure presents a visual representation of the exemplary modules of an exemplary advertising system according to the present invention. This exemplary embodiment is not limiting of the present invention and is shown herein to present just one aspect of the present invention. Other exemplary embodiments are also possible and apparent to one having ordinary skill in the art after consideration of the present disclosure. Such additional exemplary embodiments are also within the scope of the present invention.

One of the many advantages of the present invention is its applicability to all forms of ad-supported media (television, radio, print, Internet, etc.) where users contribute content or assist in filtering or selection of content. The examples presented herein and in the figure only relate to an internet service for sake of simplicity but it is to be understood that such invention can be applied to all other vehicles of delivering advertisement as well. One having ordinary skill in the art would be cognizant of the applicability of the present invention in all such other delivery vehicles after consideration of the present disclosure. All such delivery vehicles are within the scope of the present invention.

In one exemplary embodiment, the present invention allows advertisement selection by the user. The system provides an array of advertising options (specific ads and/or brands as well as categories of ads) pre-arranged in certain classes (and subclasses, if applicable) that users can choose from. Classes can be segregated by ad options which may include different formats, types of ads, positioning, timing, ability to sub-target ads within the user's content, and other parameters. Users can select the ads or classes/subclasses of ads and ad options that will be associated with their respective content. One example would be a social networking website whereby a user is provided a pallet of advertisement categories (e.g., “Automobiles”, “Clothing”, “Technology Products” etc.). The user would be required to select a prescribed number of ad categories that would be associated with the user's account and profile. Subsequently, any viewer that would view the user's profile or user content associated with his profile would be presented ads from the selected categories. In this example, the social networking site user is guiding the ads based only on category. The specific ads presented within each class would be automatically selected by the system from a catalogue of ads in each category. However, the end-user would guide the ad delivery by selecting the ad classes.

Another variant of the invention can be seen in an example where the user is presented different brands to selection from rather than categories of ads. So, on the social networking site mentioned above, a user may be presented a list of brands (e.g., “Sony”, “Casio”, “Pepsi”, “Dell”, and “BMW”). The users would be required to select a prescribed number of brands from the list. These selections made by the user would determine which brands would be advertised along with the user's content. Another example would be the case where a user is provided a variety of different ads formatted in different ways all for the same brand or multiple brands (e.g., three different ads each picturing a different athlete wearing Nike athletic gear). Based on the user's selection, the site would present ads that corresponded to the user's selection. Another example exists where the user is presented the option to select from a set of different ad components to create a composite ad (e.g., the user may be presented ten different video clips and required to select a prescribed number of clips to create a composite video ad). The resultant composite ad that is created based on the user's selections would be served along with that user's respective content. Another example exists where the user is presented the option to select different guidance criteria (e.g., categories, specific brands, different ad formats, etc.) for different parts of the users content base. So, the user in this social networking site example may select to show automobile ads on his profile page and movie ads on his blog entries. Countless other similar examples are evident to one having ordinary skill in the art after consideration of the present disclosure.

The different criteria selection methods detailed in the prior paragraph above can exist with the same system. So, for example, the operator of the social networking site may choose to offer brand-based selection to women between the ages of 35-55 while offering category-based ad selection to everyone else. The one system can provide numerous types of ad selection methods (by class including brand, by category, etc.) and can vary the ad selection method based on user attributes, including demographic criteria, timing of the day, geography, and end-user usage patterns (e.g., heaviest users select by ads by brand, while light users select by category), and the like.

In a second aspect, the present invention presents ad serving. Ad serving refers to the process of determining which ad to present with the respective content by performing a matching process (either dynamically or pre-processed) whereby targeting criteria are matched to the specific ads in turn determining which ads to display with content. In this case, the targeting criteria is determined by the user's selections and ads are then associated with that user's respective content accordingly. So, the viewers of that user's content or content that the user has programmed or filtered will be exposed to ads governed by the selections made by the user. All ads that viewers see may not necessarily be user-selected. In some cases, a blend of users-selected ads and those not selected by the user may run. This blend may change over time.

The ads may be served in a variety of different ways. The ads may be embedded directly into the content. The ads may appear around the content. There may be interstitial ads. The particular placement of the ad within the content may be apparent to one having ordinary skill in the art and depends on the content and nature of the ad and the web site or material. The association between the user's ad choices and the user's respective audience is an advantageous element of the present invention. This process can apply to most any ad campaign format existing today or new ones in the future.

As shown in FIG. 2, there is an advertiser control module that enables advertisers to design and configure their ad campaigns on the system. The control module enables the control (both manual and automatic-based on system usage patterns) of which ad options are offered to different users based on different criteria such as: demographics, usage patterns, geography, budget, timing and other dimensions. Advertisers can create audience-specific ads and maintain such ads in the advertising library or database. Then, users are offered a list of ads that such user can choose from depending on the interest of the user's audience.

Note that FIG. 2 illustrates an example implementation whereby the advertising system is operated by a publisher. The invention is equally applicable in the context of an advertising network business model where the advertising system is operated by a third party who brokers ads between a network of advertisers and a network of publishers.

Following up on the specificity of advertising to specific audiences, the present system provides reports and analytics on what ads have been selected by which users. Specifically, reports can break down selection by demographics, patterns over time, comparative rankings among different advertisers, correlations between usage patterns and user ad criteria selection as well as viewership and advertisement conversion statistics. The reports may be at a detailed or aggregate level. Advertising statistics may be optionally presented to the user who selected the ads to be posted with his or her pages or media as well. For example, a member of a social networking website using the invention outlined here can be provided viewership and advertisement conversion statistics for the ads that he selected to be presented with his content.

Considering the specificity of content and targeting of the market audience by the user, there will likely be a higher click rate and review rate of ads on user web sites. This increased click rate will result in increased exposure, sales or goodwill of the advertiser, thereby resulting in increased revenue and value. Thus, such increase value to the advertiser can be shared with the user through various modes, including, for example, revenue sharing. The system may be optionally configured with the ability for users to share in the advertising revenue that is generated from ads that appear on their respective pages. Such revenue sharing would be dependent on the number of clicks on ads of specific advertisers or the click rate or some other variable.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for presenting advertisement, the system comprising:
a portfolio of one or more advertisements made available to a user and wherein the user selects one or more advertisements or one or more category of advertisements to be associated with content generated by the user.

2. The system of claim 1, wherein the advertisements are made available to a user via an advertising network.

3. The system of claim 1, wherein the advertisements are pre-arranged in one or more classes.

4. The system of claim 1, wherein the advertisements are pre-arranged by brand.

5. The system of claim 1, wherein the advertisements are selected by assigned targeting criteria.

6. A system for presenting advertisement, the system comprising:
a portfolio of advertisements maintained by a primary host; wherein the portfolio is categorized and the advertisements are maintained within one or more classes therein; and
one or more secondary hosts; wherein each secondary host displays a predetermined number of advertisements from a predetermined number of classes from the database.

7. The system of claim 6, wherein the primary host is a web site host having multiple web site users who contribute content to the primary host.

8. The system of claim 7, wherein the secondary host is the web site user.

9. The system of claim 6, wherein the primary host is an advertiser.

10. The system of claim 6, wherein the primary host is an advertising network.

11. The system of claim 7, wherein the secondary host is a web site host.

12. The system of claim 6, wherein the class of advertisement includes categories, brands, format, time slots, content or combinations thereof.

13. The system of claim 6, wherein the primary host provides a specific array of classes to the secondary host from which to choose advertisements.

14. The system of claim 13, wherein the specific array of classes is dependent on user attributes of the secondary host.

15. The system of claim 6, further comprising one or more tertiary hosts; wherein each tertiary host chooses a predetermined number of advertisements from a predetermined number of categories from the advertisements selected by the secondary host.

16. The system of claim 15, wherein the primary host is an advertiser.

17. The system of claim 16, wherein the secondary host is a web site host.

18. The system of claim 17, wherein the tertiary host is a web site user.

19. A method for presenting advertisement, the method comprising:
categorizing one or more advertisement into one or more specific classes;
providing the classes to a user;
selecting a predetermined number of advertisement from a predetermined list of classes; and
presenting the selected advertisement.

20. The method of claim 19, wherein the user selects the advertisement.

21. The method of claim 19, wherein the providing step is taken by a host of a web site.

22. A system for presenting advertisement, the system comprising: a portfolio of one or more advertisements made available to a user and wherein the user selects one or more advertisements or one or more category of advertisements to be associated with content generated by the user.

23. The system of claim 1, wherein the advertisements are made available to a user via an advertising network.

24. The system of claim 1, wherein the advertisements are pre-arranged in one or more classes.

25. The system of claim 1, wherein the advertisements are pre-arranged by brand.

26. The system of claim 1, wherein the advertisements are selected by assigned targeting criteria.

27. A system for presenting advertisement, the system comprising: a portfolio of advertisements maintained by a primary host; wherein the portfolio is categorized and the advertisements are maintained within one or more classes therein; and one or more secondary hosts; wherein each secondary host displays a predetermined number of advertisements from a predetermined number of classes from the database.

28. The system of claim 6, wherein the primary host is a web site host having multiple web site users who contribute content to the primary host.

29. The system of claim 7, wherein the secondary host is the web site user.

30. The system of claim 6, wherein the primary host is an advertiser.

31. The system of claim 6, wherein the primary host is an advertising network.

32. The system of claim 7, wherein the secondary host is a web site host.

33. The system of claim 6, wherein the class of advertisement includes categories, brands, format, time slots, content or combinations thereof.

34. The system of claim 6, wherein the primary host provides a specific array of classes to the secondary host from which to choose advertisements.

35. The system of claim 13, wherein the specific array of classes is dependent on user attributes of the secondary host.

36. The system of claim 6, further comprising one or more tertiary hosts;
wherein each tertiary host chooses a predetermined number of advertisements from a predetermined number of categories from the advertisements selected by the secondary host.

37. The system of claim 15, wherein the primary host is an advertiser.

38. The system of claim 16, wherein the secondary host is a web site host.

39. The system of claim 17, wherein the tertiary host is a web site user.

40. A method for presenting advertisement, the method comprising: categorizing one or more advertisement into one or more specific classes; providing the classes to a user; selecting a predetermined number of advertisement from a predetermined list of classes; and presenting the selected advertisement.

41. The method of claim 19, wherein the user selects the advertisement.

42. The method of claim 19, wherein the providing step is taken by a host of a web site.
